(19) United States
(12) Patent Application Publication
(10) Pub. No.: US 2021/0406571 A1
(43) Pub. Date: Dec. 30, 2021

(54) METHOD AND APPARATUS FOR INSPECTING A LABEL ATTACHED TO A FOOD PACK

(71) Applicant: ISHIDA EUROPE LIMITED, Birmingham, West Midlands (GB)

(72) Inventor: Johnny Martin Bogedahl CHRISTOFFERSEN, Birmingham, West Midlands (GB)

(21) Appl. No.: 17/290,230

(22) PCT Filed: Oct. 30, 2019
(86) PCT No.: PCT/GB2019/053079

§ 371 Date: Apr. 29, 2021

(30) Foreign Application Priority Data
Oct. 31, 2018 (GB) 1817808.7

(51) Int. Cl. G06K 9/03; G06K 9/32; G06T 7/00; G06T 7/70

(52) U.S. Cl. CPC G06K 9/036; G06K 9/325; G06K 2209/19; G06T 7/70; G06K 2009/3291; G06T 7/001

(57) ABSTRACT

A method of inspecting a label attached to a food pack comprising: determining the location of a plurality of target portions of the label; inspecting the target portions to identify at least the presence of text and/or graphic information within each target portion; and determining whether or not each target portion successfully compares with corresponding predetermined criteria; and determining that the label is unacceptable if the total number of successful comparisons is below a predetermined acceptance threshold.

The invention relates to methods and apparatus for inspecting labels attached to food packs, particularly vacuum-packed items.

It is increasingly common practice in the food packaging industry to employ vision systems to check the label(s) on each individual food package, to confirm that the correct label has been applied, in the right place, and that correct information has been printed on the label. Typically, labels are applied to substantially horizontal and smooth surfaces, e.g. a rigid tray sealed with a plastic film. Before application, these labels are fed through a printer which provides each package with current or unique information such as date, barcode, weight, price, etc.

Using images captured by an overhead camera, commercially available image processing software can be used to carry out a number of inspections to confirm the label presence, position and content.

Because of the reasonably repeatable presentation of the labels, it is not difficult for a person trained in image inspection programming to create a program which can inspect the images and create a simple pass/fail output, which can then be used to accept or reject the package.

Some packs, though, are not rigid, smooth and horizontal. Meat products such as joints, filet of pork, leg of lamb, etc. are typically vacuum-packed, i.e. hermetically sealed in a plastic film that follows the contour of the product in all planes. When the label is applied to the product, it is often at an angle in both the horizontal and vertical plane, either wholly or partially. It is also often not applied smoothly, i.e. it may have wrinkles or waves, which typically causes further distortion and also undesired highlights (completely white) regions in the image.

This presents a difficult problem for vision systems because there is a large variation in the position and presentation of the labels from one pack to another. Using a traditional image search method which locates a known graphic feature on the label, from which all other label details can be located using simple X, Y and angle offset, does not work well at all.

One approach to this problem that has been employed in the past is to check the print quality of one or more regions of a label as part of the printing process itself. This is made possible by the printing process most often used when printing labels, but has some downsides.

Typically, printing of labels occurs through the use of thermal transfer printing. In this method of printing, an ink-carrying ribbon is positioned between a thermal print head and the substrate, with the ink provided on the side of the ribbon adjacent to the substrate. Pressure is applied to the ribbon and the substrate in the region of the print head so that, on heating, the ink, which is usually wax- and/or resin-based, melts and adheres to the substrate. The regions of the ribbon that are heated by the print head are selected such that an image is created by the wax that adheres to the substrate. This causes a negative image to be left on the ribbon.

In order to check the print quality of a label, an image may be taken of the negative image left on the ribbon. A direct comparison is then made with the expected or intended image and if the negative image is sufficiently similar it is determined that the label has been correctly printed. However, even if a label is printed correctly, problems in affixing that label to a food pack may mean that the label does not present correctly once fixed to said food pack. One cause of this is that the label will typically be printed while attached to backing paper and there could then be a failure in the mechanical transfer of the label to a food pack, for example tearing or wrinkling of the label. Another problem that could arise is that the correctly printed label may be inadvertently affixed to the wrong food pack.

Therefore, while checking the transfer ribbon may be preferable to a traditional inspection method in certain circumstances, there is nevertheless a need for an improved method of inspecting labels.

A similar problem is faced by the food product label inspection device disclosed in JP 2015/130125 A. This device is configured to detect printing defects in information related to food allergy. However, the inspection of the label occurs prior to the label being attached to a food pack. As such, it is not possible to tell if the label presents properly once attached to the food pack, which is especially problematic when the surface of the food pack is not rigid and smooth. It also possible for a label to be inadvertently affixed to the wrong food pack and for this to go undetected.

In accordance with a first aspect of the present invention, a method of inspecting a label attached to a food pack comprises:
a) determining the location of a plurality of target portions of the label;
b) inspecting the target portions to identify at least the presence of text and/or graphic information within each target portion; and
c) i) determining whether or not each target portion successfully compares with corresponding predetermined criteria; and
   ii) determining that the label is unacceptable if the total number of successful comparisons is below a predetermined acceptance threshold.

In this new method, we have recognised that one or more target portions may not be well presented for inspection and to deal with this we inspect a plurality of target portions and assess the extent to which they have been successfully compared with corresponding predetermined criteria and then determine that the label is unacceptable if the total number of successful comparisons is below a predetermined acceptance threshold. In other words, we do not rely on successfully comparing a single target portion but rather a number of target portions and use different criteria for the different target portions. This new method overcomes the problem in the prior art that a label may be printed correctly but nevertheless not present correctly once attached to a food pack.

By using “different criteria” we mean that different target portions are expected to present differently and that as a result a different comparison will be used for each target portion. Typically this means comparing each target portion with expected or reference data for that target portion, said expected or reference data being data indicating the expected appearance of the target portion. The comparison may then indicate the degree to which each target portion matches the corresponding expected or reference data, while the comparison may be considered successful if the degree to which said target portion matches the expected or reference data exceeds a predetermined comparison threshold. In some embodiments, at least one of the target portions may have a different comparison threshold to at least one other target portions. Indeed, there may be a different comparison threshold for each target portion.

In optional embodiments of the invention, the inspection of the print ribbon is still carried out prior to attaching the label to a food pack. If this inspection indicates that the label has not been correctly printed then the label is rejected. Conversely, if this inspection indicates that the label has been correctly printed then the label is attached to the food pack, after which the inspection of the label itself is carried out. This means that it is possible to be sure that the label has at least been printed correctly, with the subsequent inspection of the label ensuring that the label presents correctly once attached to a food pack. The benefit of inspecting the print ribbon is that even if one or more target portions are not visible during the inspection of the label, an operator can be confident that those target portions were at least printed correctly. Therefore, by inspecting the print ribbon, the confidence in the results of the inspection of the label may be increased.

Although each target portion could be assessed on the basis of similar importance, in preferred applications, wherein one or more target portions is classified as critical, the method may comprise: c) iii) determining that the label is unacceptable if one or more of said critical target portions does not successfully compare with the corresponding predetermined criteria.

Examples of target portions include:
the presence of a label on the food pack,
the packing date,
the presence of a bar code,
the bar code itself,
best before date,
weight, a QR code,
price, and/or
production date.

In embodiments in which some target portions are classified as critical, any of the above may be classified as critical, although preferably at least the presence of a label on the food pack, the packing date, and the presence of a bar code would be classified as critical in such embodiments.

In practice, a user can decide which types of target portion will be classified as critical, which will vary with application.

There are a number of known ways in which the location of the target portions can be determined but in a preferred example, step a) comprises:
ai) scanning the food pack to obtain an image of the area of the food pack containing a label;
aii) determining the location of the label on the food pack by comparing the scanned image at a first resolution with a predetermined label portion template; and
aiii) using the location of the label to determine the location of the target portions.

This allows a relatively rough scan to be carried out to determine the overall location of the label, for example the coordinates of a corner of the label from which the location of the target portions can be determined from knowledge of their location on a standard, unused label.

Typically, steps ai) and aiii) are carried out at a resolution higher than the resolution used in step aii).

Thus, step aii) is carried out at a relatively low resolution compared with the step of inspecting target portions. This is because the search process can have a reduced sensitivity to variation in the presented label image, resulting in a successful search even for very poorly presented labels. Thus, providing the area scanned in step ai) is large enough, it is normally possible to identify an aspect which can be found in the predetermined label portion template and this can be achieved relatively quickly by operating at a lower resolution.

In some examples, the food pack could be scanned at the higher resolution and subsequently rescanned at the lower resolution. Preferably, however, the food pack is scanned at the high resolution, and the lower resolution version of the image is obtained from the high resolution version using interpolation or the like.

In either case, the method preferably further comprises after step aii), calculating the position of the label at the second resolution for use in step aiii).

The choice of resolution and the relationship between the resolutions will normally need to be determined empirically depending upon the particular food packs being processed. A typical low resolution is about two pixels/mm while a typical high resolution is 10 pixels/mm. Thus, the high resolution is five times the low resolution but other relationships are possible.

The predetermined label portion template is selected to enable corresponding areas of a label to be identified even when the label is being poorly presented. This is preferably achieved by using a template corresponding to the full known label surface although in some cases a template corresponding to a smaller portion of the label surface could be used. Another approach is to identify portions of the known label which exhibit a border having a detectable or sharp transition in one or more of hue, luminance and intensity and are thus more easily detectable when the label is poorly presented.

In general, it is preferred that the predetermined label portion template defines a portion of the known label that presents a graphic image since this is more readily identified than portions that include text. Nevertheless, certain text portions could be utilized for this purpose.

In the preferred approach, however, step aii) comprises comparing geometric features of the scanned image with the label portion template.

Step b) will typically comprise applying a text recognition algorithm to target portions that are expected to include text and a pattern matching algorithm to target portions expected to include a graphical image. Since more accuracy is required in steps b) and c), preferably step a) is carried out using a pattern matching algorithm having a threshold set at a lower confidence level than that of text and/or pattern matching algorithms used in step b) and/or c).

Typically, the label will not be presented in an expected orientation for the purposes of the algorithms applied in step b) and step c). In view of this, the target portions that are identified will also not be presented in the correct orientation. This can be dealt with by modifying the algorithm according to the orientation of the label.

In accordance with a second aspect of the present invention, apparatus for inspecting a label attached to a food pack comprises a scanning system for scanning the food pack; and processing means adapted to carry out a method according to the first aspect of the invention based upon data obtained by the scanning system.

Typically, the scanning system will comprise a single scanning station which can be adapted to scan the label at a second high resolution while the processing means is adapted to form a first, lower resolution version for use in determining the location of the label.

Normally scanning will be carried out in the visible wavelength range but in some cases scanning of target portion(s) outside the visible could be carried out to identify covert features.

Following the result of the inspection, the food pack is either accepted and fed to the next process in the food packaging operation or is rejected by diverting the food pack to a reject location in a conventional manner.

An example of a method and apparatus according to the invention will now be described with reference to the accompanying drawings, in which:—

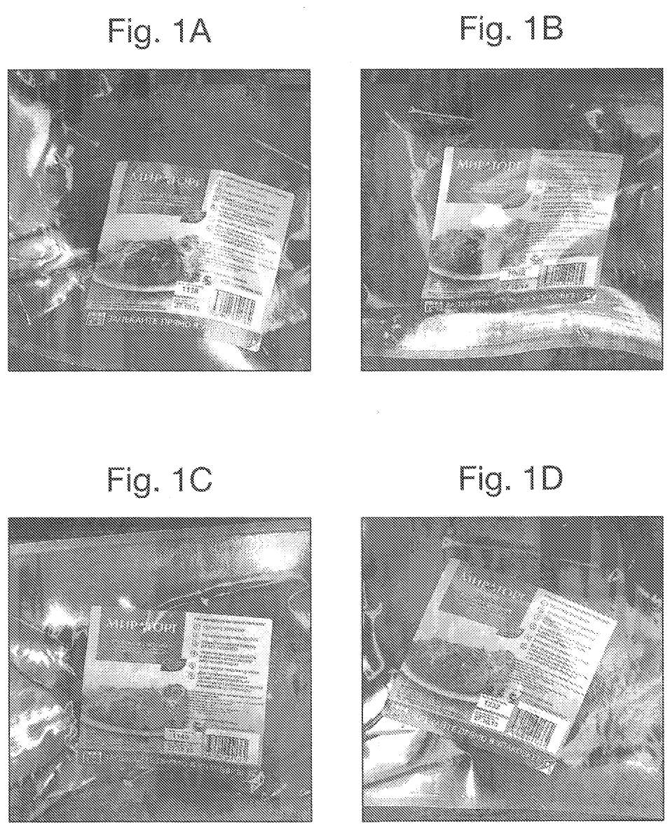

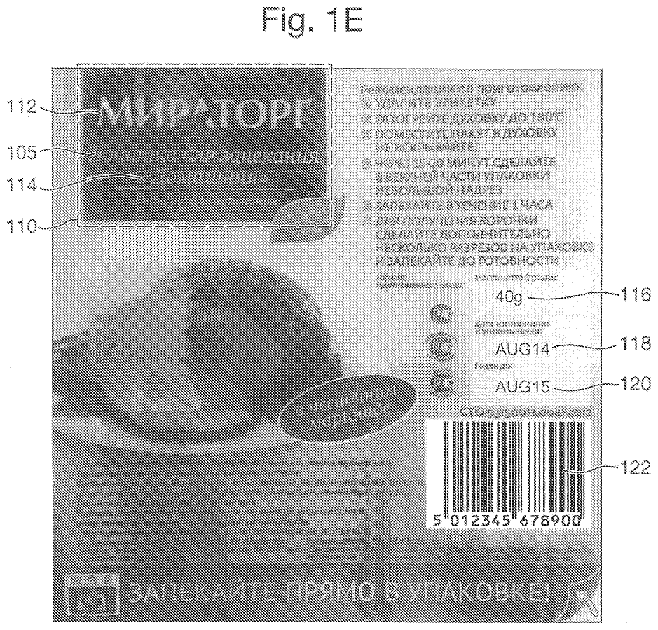

FIGS. 1A-1D are photo images of a label on a food pack illustrating different ways in which the label can be distorted, while FIG. 1E Illustrates an undistorted label;

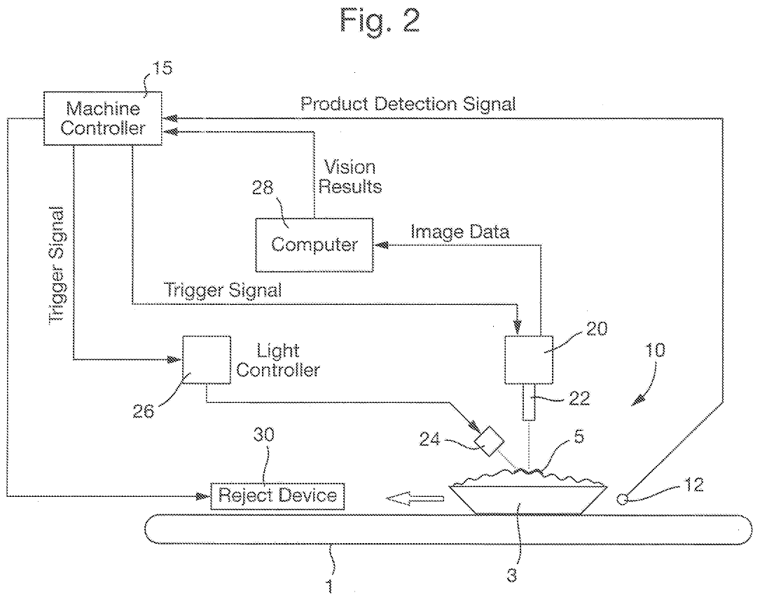

FIG. 2 is a schematic diagram of an embodiment of the apparatus;

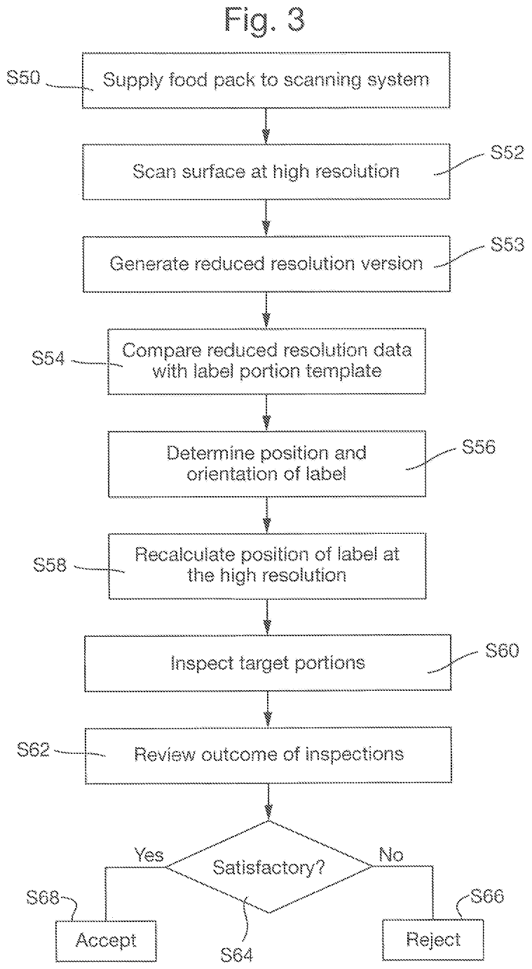

FIG. 3 is a flow diagram illustrating operation of the apparatus shown in FIG. 2;

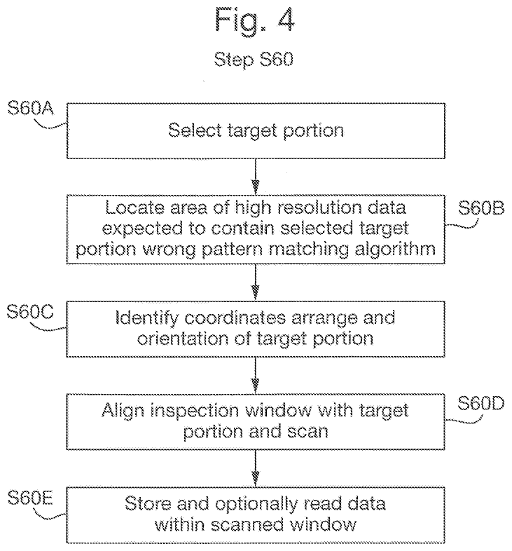

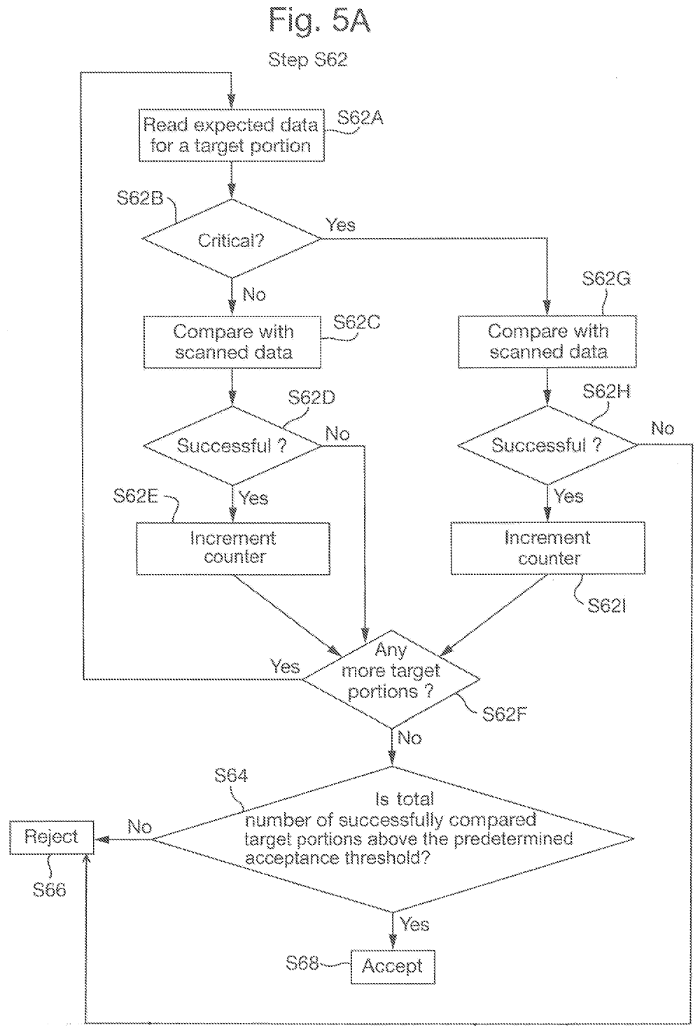

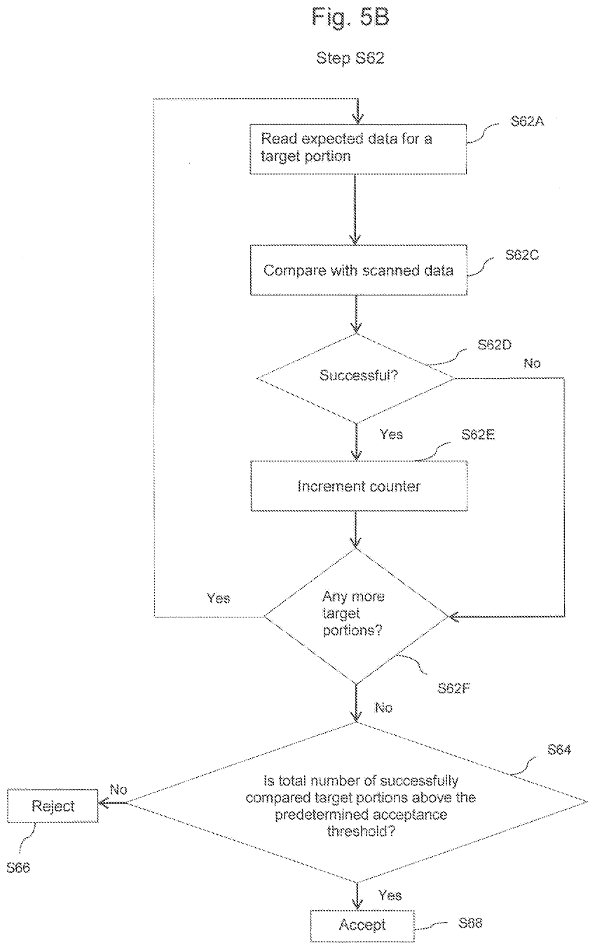

FIGS. 4, 5A, and 5B are flow diagrams illustrating certain steps from FIG. 3 in more detail;

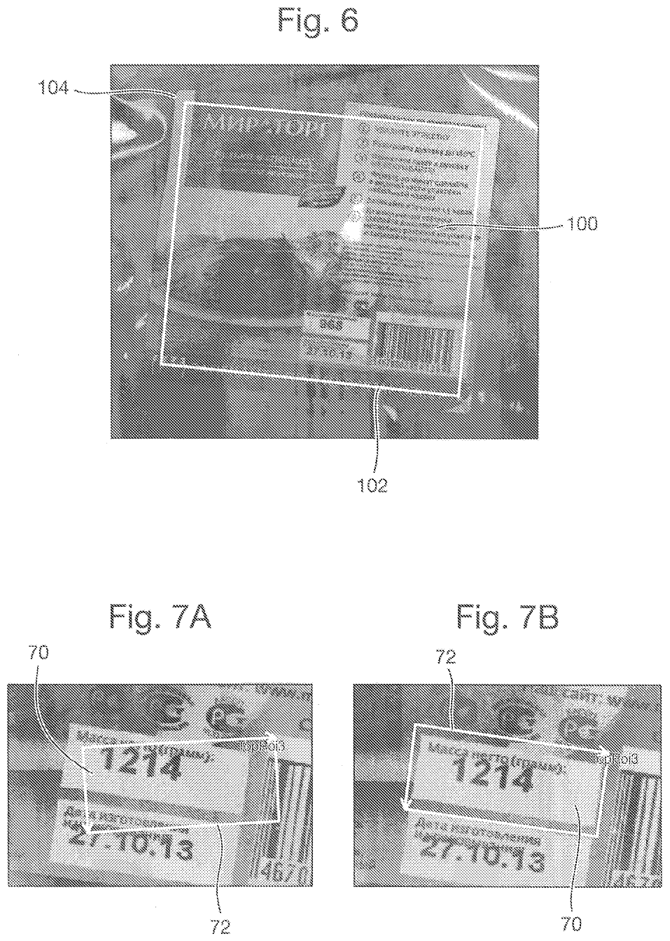

FIG. 6 illustrates an example of the size of a label portion template compared with an actual label portion; and

FIGS. 7A and 7B illustrate how the orientation of part of a label is compensated for.

As explained above, the present invention is concerned with inspecting labels on food packs, particularly where the surface of the food pack on which the label is provided is uneven. This problem arises particularly with vacuum-packed products where the vacuum packing film follows the contour of the product. FIGS. 1A-1D illustrate four different examples of vacuum-packed products carrying labels and in which the labels have been distorted.

It is necessary, however, despite the distortions, to be able to obtain data from the labels so that this can be checked and the pack verified. If a system is used which expects the label to be presented in a convenient, flat manner then it is likely that the data on the label will not be accurately read resulting in food packs being rejected and significant waste being generated.

An example of an apparatus for inspecting these labels on food packs is shown in FIG. 2. The apparatus comprises a conveyor 1 of conventional form to which food packs 3, typically plastic trays in which a food product is located and has been vacuum-packed, are fed. In some cases, trays are omitted. A label 5 is shown adhered on the outer surface of the food pack 3.

The food pack is initially supplied to a scanning system 10, the arrival of the food pack being detected by a sensor 12, such as a light beam, the output of which is fed to a machine controller 15.

The scanning system 10 comprises a line-scanning camera 20, with a lens 22, which can be controlled to undertake a raster scan across the surface of the food pack 3 located beneath it. Alternatively, an area-scan camera could be used which captures the entire surface in one shot but this requires large area illumination at high intensity in order to achieve clear images at high resolution. The line scan camera is preferred since this enables the benefit of variable-length images to be obtained.

A light source 24, such as an LED array, within the scanning system 10 is controlled by a light controller 26 in response to trigger signals from the machine controller 15.

The camera 20 is activated when a food pack 3 is ready to be scanned, by a controlled trigger signal from the machine controller 15, following which it obtains successive exposures of lines of pixels on the surface of the food pack 3. The resultant pixel data is supplied to a process computer 28. The process computer 28 determines whether or not the food pack 3 can be accepted depending upon the information obtained from the label and outputs a suitable result to the machine controller 15.

The machine controller 15 then controls the conveyor to pass the food pack 3 on to the next stage in the packing process if the label is acceptable or activates a reject device 30 such as a guide arm to guide the food pack 3 to a reject location (not shown). The process carried out by the computer 28 in conjunction with the scanning system 10 will now be described.

Initially, in step S50 (FIG. 3) a food pack 3 is delivered by the conveyor 1 to the scanning system 10.

The machine controller 15 responds to the signal from the product sensor 12 indicating that the food pack 3 has arrived to send trigger signals to the light controller 26 and to the camera 20 such that the light 24 is turned on to illuminate an area on the surface of the food pack 3 where a label 5 is expected while the camera 20 operates to scan in a raster fashion successive pixels of the illuminated area at a high resolution (step S52). An example of a suitable resolution is 10 pixels/mm.

The scanned pixel data, typically 8 bit monochrome i.e. defining intensity (but could be defined in terms of LCH or CMYK digital data), for each pixel is supplied to the computer 28 where it is stored in a memory (not shown). The computer generates and stores a lower or reduced resolution version of the image, typically at 2 pixels/mm (step S53).

The computer 28 then compares the reduced resolution image with a predetermined label portion template 110 (FIG. 1E) also stored in the computer 28 (step S54). The label portion template is a user-defined area of a known label which is suitable for detection even if the label is in a distorted condition. For example, a label portion having a dark area surrounded by a lighter border is suitable since the transition in lightness or intensity can be detected. In general, a label portion having graphic information is preferred to one with just text since the former is more easily identified. It is also preferable to use a template defining a relatively large area of the label, e.g. 80% or more, so that at least a portion of the template can be matched.

Step S54 involves applying a geometric matching process based on feature lines using a known matching algorithm but using a relatively low acceptance score setting and thus is able to accept variations in presented features from the ideal because it is being used only for location information. An example is the “Sherlock” image processing software sold by Teledyne Dalsa and using the “Search-Geometric” pattern matching tool.

FIG. 6 illustrates an example of a package having a label 100 and indicates by means of a square outline 102 the area defining the label portion template. It will be understood, of course, that the label 100 may not be presented to the scanning system in exact alignment with the template 102 and thus some realignment of the scanned data may be necessary using conventional interpolation techniques or the like in order to optimize the match comparison.

The output of the process just described is typically the position and angle of the found label portion with the coordinate origin being at the top left of the image as indicated at 104 in FIG. 6. The position is defined by the centre of the detected area while the orientation of the found label relative to the horizontal axis shown in FIG. 6 is also determined (step S56).

At this point, the position of the scanned label 105 (FIG. 1E) is defined with respect to the coordinate origin (X=0, Y=0) at the top left of the image as shown at 104 in FIG. 6 and this will be defined in terms of pixel positions at the reduced resolution, e.g. X=300, Y=200. This position is then converted by the computer 28 (step S58) to an equivalent position at the high resolution of 10 pixels/mm, i.e. a position of X=1500, Y=1000 (step S58). The orientation angle does not need to be scaled as it remains the same at both resolutions.

Once the position of the label has been determined, together with its orientation, it is possible to identify areas where one or more target portions of the label are expected to be located and which it is desired to inspect. Thus, in a known label (FIG. 1E), there are particular target portions which need to be inspected (step S60). These include items (some shown in FIG. 1E) such as:

### Logotype 112

Product name 114
Best before date 120
Production date 118

### Weight 116

### Price

### Price/kg

Batch code

### Barcode 122

Datamatrix or QR code
Veterinary stamp (oval symbol with code inside)
Numerals printed under the barcode
Table of nutritional values
List of ingredients
Countries of birth, rearing, slaughter and packaging

Once a target portion is selected (step S60A, FIG. 4), the process computer 28 is controlled (step S60B) to locate an area of the high resolution data, relative to the determined coordinate origin of the scanned label, where the target portion is to be expected. This process involves utilizing a pattern matching algorithm (Sherlock mentioned above set to “Verify Pattern”) to identify the approximate area of the target portion and to output the X and Y coordinates of the target portion origin together with the orientation of the target portion (step S60C). The pattern matching algorithm is desensitized by reducing the required pattern match score so as to cope with distortions at local level.

Once the coordinate origin of the target portion has been determined, and its orientation known, an inspection window for the corresponding target portion is aligned with the target portion and pixels of the high resolution data within the window are scanned (step S60D). FIG. 7A illustrates a target portion 70 defined by a weight “1214” and inspection window 72 of rectangular form overlaid on the food pack as it is presented.

With knowledge of the exact position and orientation of the target portion, the computer 28 rotates the window 72 so it is aligned with the target portion 70 (FIG. 7B) and following alignment, information within the target window can be read from the stored high resolution data, for example using an OCR technique or the like, the read data then being stored (step S60E).

The output of this process (step S60) is typically plain text defining information such as weight, price etc. as explained above.

This process is repeated as desired for other target portions so as to build up information about more than one type of data on the label. Some portions will be graphic and therefore a pattern matching algorithm will be used instead of OCR.

In both cases, a higher acceptance score will be set, e.g. around 70% (much higher than used in step S54).

In order to decide whether the presented label is satisfactory or not, the information (text or graphics) read from the target portions is then reviewed (step S62).

Initially, in step S62A (FIG. 5A) the expected data for a target portion is read and the processor may look up in a previously stored directory whether this data is classified as critical (step S62B). A critical target portion (for example the presence of a label) must be successfully compared with corresponding predetermined criteria if the label is to be judged acceptable.

If the target portion data is not critical then step S62C is performed in which the scanned data is compared with expected or reference data. If that comparison is successful and the degree of match exceeds a predetermined comparison threshold (step S62D) then a counter of target portions successfully compared is incremented by one (step S62E) and processing moves on to step S62F. If, on the other hand, the comparison at step S62C is not successful then the counter is not incremented and processing moves to step S62F.

If the target portion is unsuccessfully compared with the expected data in step S62C, processing is directed at step S62D directly to step S62F and the counter is not incremented.

Different expected or reference data is typically used in step S62C for different target portions. For example, a scanned bar code will be compared with data indicating the expected appearance of that bar code, whereas a scanned best before data will have a different expected appearance. The degree of match may also be required to exceed different predetermined comparison thresholds for different target portions in step S62D.

If in step S62B the target portion is determined to be a critical target portion then the scanned data for that target portion is compared with expected or reference data in step S62G. If the comparison is successful (step S62H), the counter of target portions that have been successfully compared is incremented (step S62I) and processing moves on to step S62F.

If the comparison at step 62G is not successful, the label is immediately rejected (step S66). This is because all critical target portions must be successfully compared with their predetermined references.

Similarly to steps S62C and S62D, different expected or reference data will typically be used in step S62G for different target portions, while the degree of match may also be expected to exceed a different predetermined comparison threshold for each target portion in step S62H.

At step S62F, a decision is made as to whether any further target portions need to be evaluated and, if so, processing returns to step S62A. Otherwise, the process moves to step S64.

FIG. 5B shows the progression from step S62C to step S64 for embodiments in which data is not classified as either critical or non-critical. As with FIG. 5A, in step S62A the expected data for a target portion is read. As the data is not classified as critical or non-critical data, step S62B is skipped and the process proceeds to step S62C.

At step S62C the scanned data is compared with expected or reference data. If that comparison is successful and the degree of match exceeds a predetermined comparison threshold (step S62D) then a counter of target portions successfully compared is incremented by one (step S62E) and processing moves on to step S62F. If, on the other hand, the comparison at step S62C is not successful then the counter is not incremented and processing moves to step S62F.

If the target portion is unsuccessfully compared with the expected data in step S62C, processing is directed at step S62D directly to step S62F and the counter is not incremented.

Different expected or reference data is typically used in step S62C for different target portions. For example, a scanned bar code will be compared with data indicating the expected appearance of that bar code, whereas a scanned best before data will have a different expected appearance. The degree of match may also be required to exceed different predetermined comparison thresholds for different target portions in step S62D.

At step S62F, a decision is made as to whether any further target portions need to be evaluated and, if so, processing returns to step S62A. Otherwise, the process moves to step S64.

In step S64, a decision is made as to whether or not the label is satisfactory allowing the product to proceed (step S68) or unsatisfactory in which case the product must be rejected (step S66). This is carried out by comparing the total number of successfully compared target portions with a predetermined acceptance threshold. If the total number of successfully compared target portions is above the predetermined acceptance threshold, the label is accepted. Else, the label is rejected.

In one set of predetermined conditions, first, inspections which have been selected as critical must be successful (as described above), while a minimum number of inspections have to be successful. As a result, the system becomes tolerant to imperfections but overall gives a clear indication that the label was applied and that at least some information was printed on the label, and based on this there is a high probability that all areas have been printed correctly as the printing is performed by the same device.

Using the label drawing in FIG. 1E, examples of different sets of predetermined conditions are given below.

Example 1: Initial label search; Set to critical
Best before date; Set to non-critical
Weight; Set to non-critical
Packing date; Set to non-critical
Barcode; Set to non-critical
Barcode as graphic feature; Set to critical
Overall required score set to 3, i.e. two critical target portions plus at least one non-critical portion are successfully compared

In an alternative set of predetermined conditions, an overall required score could be set to 4, with no target portions set to critical.

Example 2: Initial label search; Set to critical
Best before date; Set to non-critical
Weight; Set to non-critical
Packing date; Set to critical
Barcode; Set to non-critical
Barcode as graphic feature; Set to non-critical
Overall required score set to 5, i.e. two critical plus at least three non-critical target portions.

Example 1 will guarantee that the label is present and that a barcode-like feature (which will be the barcode) and at least one other item (barcode data, QR code, weight or date) is present.

Example 2, while guaranteeing presence of the label and many items, is likely to result in many rejects because the overall required score might not be reached.

It will be recognised that many different combinations can be predetermined depending upon the labels concerned, the combinations being chosen so as to balance the risk of wrongly accepting an incorrect label against increasing the level of waste due to discarded labels and food packs.

The predetermined conditions could include a further step (not shown in the drawings) in which it is determined that each target portion is successfully compared with the corresponding predetermined criteria at least once over a predetermined number of food packs such as 10 or 20. If that comparison proved unsuccessful at any time, then the process would be stopped for example, if none of the food packs had a barcode.

As noted earlier, the inspection of the label may be carried out in conjunction with an inspection during the printing stage. Specifically, if the label is printed using thermal transfer printing, the quality of the printing may be checked by inspecting a negative image of the label left on the ribbon used during this printing process.

Because the print ribbon is substantially flat, the inspection can be carried out by simply comparing the negative image on the print ribbon with an expected or intended image. If the similarity between the two is below a predetermined threshold, the label is unacceptable and is discarded. If the similarity is above said threshold, the label is attached to the food pack.

Inspecting the print ribbon has the benefit of improving the confidence in the results of the inspection of the label itself, as although some of the target portions may not be visible during the inspection of the label, those portions will at least have been printed correctly, else the label would not have been attached to the food pack.

Once the label has been attached to a food pack, the inspection of the label described above is carried out. This inspection will usually be the same as has been described, regardless of whether the print ribbon has also been inspected, with a number of target portions being identified and compared with expected or reference data to determine if a sufficient number of target portions compare successfully for the label to be considered satisfactory. As before, some of the target portions may be considered as critical. If this inspection indicates that the label is unacceptable then the food pack is not allowed to pass onto the next stage of production. If none of the inspections of the label have indicated it is unacceptable, then the food pack is allowed to pass onto the next stage of production.

1. A method of inspecting a label attached to a food pack comprises:
a) determining the location of a plurality of target portions of the label;
b) inspecting the target portions to identify at least the presence of text and/or graphic information within each target portion; and
c) i) determining whether or not each target portion successfully compares with corresponding predetermined criteria; and
ii) determining that the label is unacceptable if the total number of successful comparisons is below a predetermined acceptance threshold;
wherein the food pack has an uneven surface on which the label is provided;
wherein the predetermined acceptance threshold is less than the total number of determined target portions.

2. A method according to claim 1, wherein one or more target portions is classified as critical, whereby the method further comprises:
c) iii) determining that the label is unacceptable if one or more of said critical target portions does not successfully compare with the corresponding predetermined criteria.

3. A method according to claim 1, wherein said corresponding predetermined criteria comprises expected or reference data indicating the expected appearance of the target portion.

4. A method according to claim 3, wherein the comparison of each target portion with corresponding predetermined criteria indicates the degree to which said target portion matches the expected or reference data.

5. A method according to claim 4, wherein the comparison is successful if the degree to which said target portion matches the expected or reference data exceeds a predetermined comparison threshold.

6. A method according to claim 5, wherein at least one of the target portions has a different predetermined comparison threshold to at least one other target portion.

7. A method according to claim 1, wherein the target portions are selected from one or more of:
the presence of a label on the food pack,
the packing date,
the presence of a bar code,
the bar code itself,
best before date,
weight,
a QR code,
price,
production date.

8. A method according to claim 1, wherein step a) comprises:
ai) scanning the food pack to obtain an image of the area of the food pack containing a label;
aii) determining the location of the label on the food pack by comparing the scanned image with a predetermined label portion template; and
aiii) using the location of the label to determine the location of the target portions.

9. A method according to claim 8, wherein steps ai) and aiii) are carried out at a resolution higher than the resolution used in step aii).

10. A method according to claim 9, wherein the lower resolution version used in step aii) is obtained from the higher resolution version used in step ai).

11. A method according to claim 9, wherein the higher resolution is more than twice the lower resolution and preferably up to five times the lower resolution.

12. A method according to claim 1, wherein step b) comprises applying a text recognition algorithm to at least one of the target portions that is expected to include text.

13. A method according to claim 1, wherein step b) comprises applying a pattern matching algorithm to at least one of the target portions that is expected to include a graphical image.

14. A method according to claim 1, wherein step a) is carried out using a pattern matching algorithm having a threshold set at a lower confidence level than that of text and/or pattern matching algorithms used in step b) and/or c).

15. A method according to claim 1, wherein step a) includes determining the orientation of each target portion and step b) carries out the inspection while taking account of that orientation.

16. A method according to claim 1, wherein the food pack comprises a foodpiece that has been vacuum-packed with a film to which the label is attached.

17. A method according to claim 1, wherein the label is provided on a curved or slanted surface of the food pack.

18. Apparatus for inspecting a label attached to a food pack, the apparatus comprising a scanning system for scanning the food pack; and processing means adapted to carry out a method according to claim 1 based upon data obtained by the scanning system.
